(19) United States
(12) Patent Application Publication
(10) Pub. No.: US 2003/0147421 A1
(43) Pub. Date: Aug. 7, 2003

(54) Method and apparatus for dynamic host configuration protocol lease time determination

(76) Inventors: Gary Robert Gutknecht, Noblesville, IN (US); David Lee Ryan, Noblesville, IN (US); Mark Ryan Mayernick, Carmel, IN (US)

Correspondence Address: JOSEPH S. TRIPOLI, THOMSON MULTIMEDIA LICENSING INC., 2 INDEPENDENCE WAY, SUITE #2, P.O. BOX 5312, PRINCETON, NJ, 08543-5312, US

(21) Appl. No.: 10/339,750

(22) Filed: Jan. 9, 2003

Related U.S. Application Data
(60) Provisional application No. 60/355,665, filed on Feb. 6, 2002.

(51) Int. Cl. H04J 3/16

(52) U.S. Cl. 370/468; 370/442

(57) ABSTRACT

A method and apparatus for dynamic host configuration protocol lease time determination by receiving at a first dynamic host configuration protocol device, a message requesting allocation of an IP address to a client, and allocating to the requesting client a relatively short lease time, if a second dynamic host configuration protocol device does not contain the requested IP address lease.

### CROSS-REFERENCE TO RELATED APPLICATIONS

This application claims the benefit of U.S. Provisional Application Ser. No. 60/355,665, filed Feb. 6, 2002; which is incorporated herein by reference in its entirety.

### FIELD OF THE INVENTION

This invention relates to the field of data networks and, more specifically, to Dynamic Host Configuration Protocol (DHCP) leases in data networks.

### BACKGROUND OF THE INVENTION

The Internet provides multimedia content including audio, video, graphics and text that often require wide bandwidth for downloading and viewing. Many Internet Service Providers (“ISPs”) allow customers to connect to the Internet via a telephone line from a Public Switched Telephone Network (PSTN) at various data rates, including 14,400 bps, 28,800 bps, 33,600 bps and 56,000 bps.

Cable television networks, on the other hand, are typically interconnected by cables such as coaxial cables or Hybrid Fiber/Coaxial (“HFC”) cable systems, which have data rates of about 10 Mega-bits-per-second (“Mbps”) to 30+ Mbps. These data rates are much higher than the data rates available on the PSTN. With the explosive growth of the Internet many users have begun using broadband connections, such as that provided by cable modems, due to the greater bandwidth provided.

In a typical network, such as the Internet, a subnet, or an intranet, a Dynamic Host Configuration Protocol (DHCP) is often used. Dynamic Host Configuration Protocol (DHCP) is a protocol defining the method by which a server assigns Internet Protocol (IP) addresses to requesting clients for a defined period of time (known as a lease time). The IP addresses are used by client premises equipment (CPE) devices to communicate with other devices that are connected to the network. One advantage of using the DHCP to obtain IP addresses is that other configuration information that is important to the network device may be obtained in a single exchange of messages. The DHCP protocol is defined in Request for Comments (“RFC”) RFC-2131 and RFC-2132, an Internet standards track protocol standardized by the Internet Engineering Task Force (IETF).

An edge networking device such as a cable modem or router oftentimes contains an embedded DHCP server used to provide PCs or other CPE devices with IP addresses that are on a subnet isolated from the Wide Area Network (WAN). These CPE devices do, though, oftentimes need to have WAN access for exchanging information with other devices on the WAN side of the edge network device. One example is the downloading of a web page, in which case a CPE device contacts a Domain Name Server (DNS) to resolve the Internet name to an IP address. As such, the embedded DHCP server provides DNS and other WAN-type information to the CPE devices.

In addition to these edge networking devices having embedded DHCP servers, they often also have an embedded DHCP client for obtaining its own IP addresses that belong to the WAN subnet. Upon successful completion of the DHCP client obtaining a WAN IP lease, the client oftentimes then has information relevant to the embedded DHCP server such as DNS IPs.

One shortcoming associated with DHCP as defined by RFC-2131 and RFC-2132 is that once a lease is given out by a DHCP server, the server has no opportunity to reclaim or change the lease until the client tries to renew the lease at a later time. This later time is upper bound by the lease time given in the DHCP server's lease request acknowledgement and can result in a delay or inactivity. For example, if the DHCP client has not been granted a DHCP lease by a WAN server the DHCP client does not have the information requested by the CPE and a lease grant by a DHCP server to the CPE will be ineffective because the requested data will not be present in the DHCP client and therefore cannot be transferred.

### SUMMARY OF THE INVENTION

The invention comprises a method and apparatus for dynamic host configuration protocol (DHCP) lease time determination, such that inactivity is minimized and CPE devices are presented with WAN-type information as soon as it becomes available.

A method, according to one embodiment of the invention, for DHCP lease time determination includes receiving at a first dynamic host configuration protocol (DHCP) device, a message requesting allocation of an IP address to a client, and allocating to the requesting client a relatively short lease time, if a second DHCP device does not contain the requested IP address lease.

An apparatus, according to one embodiment of the invention for DHCP lease time determination includes a first DHCP device, for receiving messages from a client system and issuing lease times to the client system in response to the messages, the messages requesting allocation of IP addresses, a second DHCP device, for receiving IP address leases from a wide area network associated with the requested IP addresses, a memory for storing communications parameters and instructions, and a processor. The processor, upon executing the instructions, is configured to receive at a first DHCP device, a message requesting allocation of an IP address to a client, and allocating to the requesting client a relatively short lease time, if a second DHCP device does not contain the requested IP address lease.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of an Internet network, including an embodiment of the present invention;

FIG. 2 depicts a high-level block diagram of an embodiment of a NAT device suitable for use in the Internet network of FIG. 1;

FIG. 3 depicts a block diagram illustrating a network address translation process of the NAT device of FIG. 1 and FIG. 2 in accordance with the principles of the present invention; and

FIG. 4 depicts a flow diagram of an exemplary method in accordance with the principles of the present invention.

To facilitate understanding, identical reference numerals have been used, where possible, to designate identical elements that are common to the figures.

### DETAILED DESCRIPTION OF THE INVENTION

The subject invention will be described within the context of a computer network and associated devices connected to the Internet. However, it will be appreciated by those skilled in the art that the subject invention may be advantageously employed in any communications system utilizing a Dynamic Host Configuration Protocol (DHCP). Thus, it is contemplated by the inventors that the subject invention has broad applicability beyond the network systems described herein.

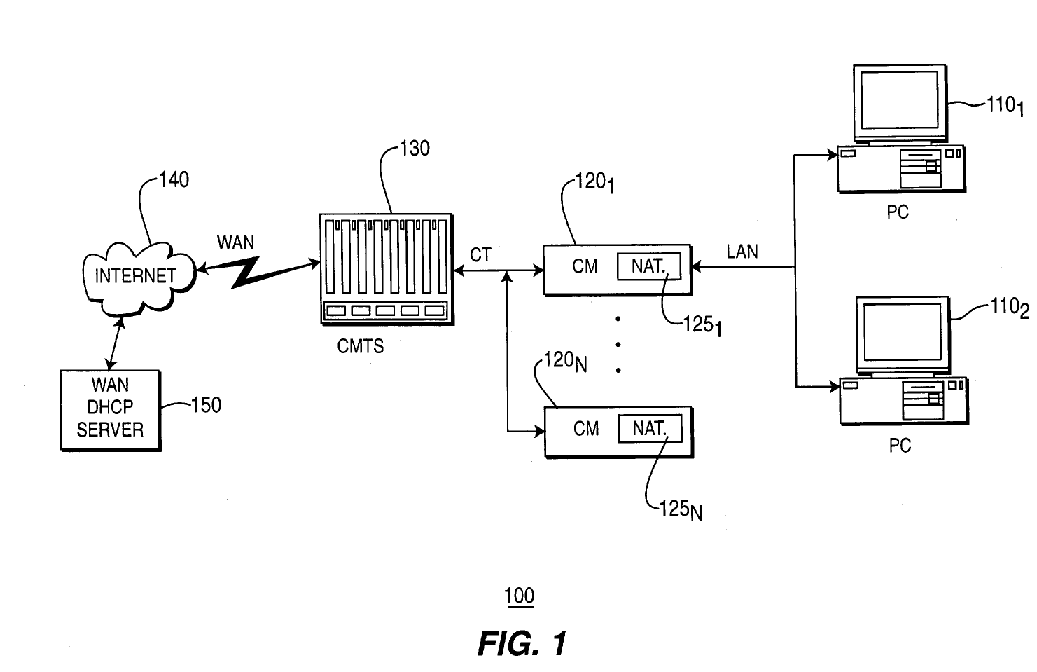

FIG. 1 depicts a high-level block diagram of a network 100 including an exemplary embodiment of the present invention. The network 100 of FIG. 1 comprises a plurality of computer premises equipment (CPE) devices (illustratively two personal computers (PCs)) 1101 and 1102 (collectively PCs 110), a plurality of edge networking devices (illustratively a plurality of cable modems (CMs)) 120₁-120_{N}, a cable modem termination system (CMTS) 130, and the Internet 140. The two PCs 110 comprise a local area network (LAN) and the Internet 140 comprises a wide area network (WAN). The WAN further comprises a WAN DHCP server 150. Additionally, the CMs 120₁-120_{N} of FIG. 1 each comprise a respective network address translator (NAT) device 125₁-125_{N}. The NAT devices 125₁-125_{N} provide IP addresses and configuration parameters for communication between the LAN and the WAN. Although in FIG. 1 the NAT devices 125₁-125_{N} are depicted as being incorporated within the CMs 120₁-120_{N}, it will be appreciated by those skilled in the art that the NAT devices 125₁-125_{N} can be incorporated in other edge networking devices such as routers. Alternatively, the NAT devices 125₁-125_{N} can comprise separate units cooperating with the CMs 120₁-120_{N}.

During upstream transmission, a DHCP lease request (IP lease request) is generated in the LAN (i.e., by a PC 110). The DHCP lease request is communicated to a respective CM 120. The CM 120 modulates the signal from the PC 110 for upstream communication across a cable transport (CT) network. The CM 120 also acts as an identifier or relay agent that is associated by the Internet 140 for communications with the particular LAN devices (PCs 110). The NAT device 125 of the CM 120 provides an Internet Protocol (IP) address for upstream communication to the Internet 140. The IP address provided by the NAT device 125 includes all relevant fields/parameters necessary for communication with the Internet 140. The list of parameters typically includes Domain Name Server (DNS) IP addresses and domain name. The operation of the NAT 125 will be described in greater detail below.

The CMTS 130 receives the signals from the CM 120 and converts these signals into IP packets (if not already done), which are then sent to an IP router (not shown) for transmission across the Internet 140.

During downstream transmission, information from the Internet 140 is received by the CMTS 130. The CMTS 130 modulates the downstream signals for transmission across the CT network. The CM 120 demodulates the downstream signal. The NAT device 125 within the CM 120 provides an IP address for communication with the requesting PC 110. The operation of the NAT device 125 will be described in greater detail below.

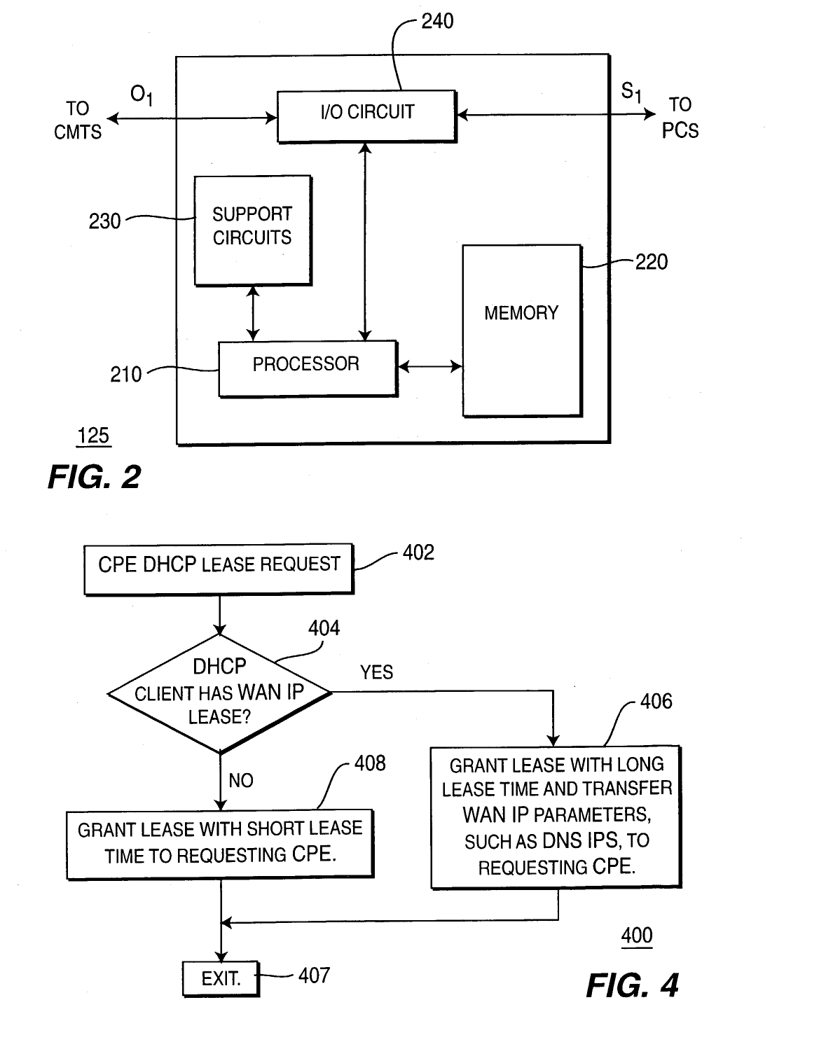

FIG. 2 depicts a high-level block diagram of an embodiment of a NAT device suitable for use in the Internet network of FIG. 1. The NAT device 125 of FIG. 2 comprises a processor 210 as well as a memory 220 for storing the algorithms and control programs. The processor 210 cooperates with conventional support circuitry 230 such as power supplies, clock circuits, cache memory and the like as well as circuits that assist in executing the software routines stored in the memory 220. As such, it is contemplated that some of the process steps discussed herein as software processes may be implemented within hardware, for example, as circuitry that cooperates with the processor 210 to perform various steps. The NAT device 125 also includes input-output circuitry 240 that forms an interface between the various elements communicating with the NAT device 125. For example, in the embodiment of FIG. 1, the NAT device 125 communicates with the PCs 110 via a signal path S1 and to the Internet 140 via signal path O1.

Although the NAT device 125 of FIG. 2 is depicted as a general purpose computer that is programmed to perform various control functions in accordance with the principles of the present invention, the invention can be implemented in hardware, for example, as an application specific integrated circuit (ASIC). As such, the process steps described herein are intended to be broadly interpreted as being equivalently performed by software, hardware, or a combination thereof.

Furthermore, although the NAT device 125 of FIG. 2 is depicted as a general purpose computer that is programmed to perform various control functions in accordance with the present invention, the NAT device 125 can be incorporated as software into an existing computer of a device, such as a router or a cable modem, to be upgraded with the NAT feature.

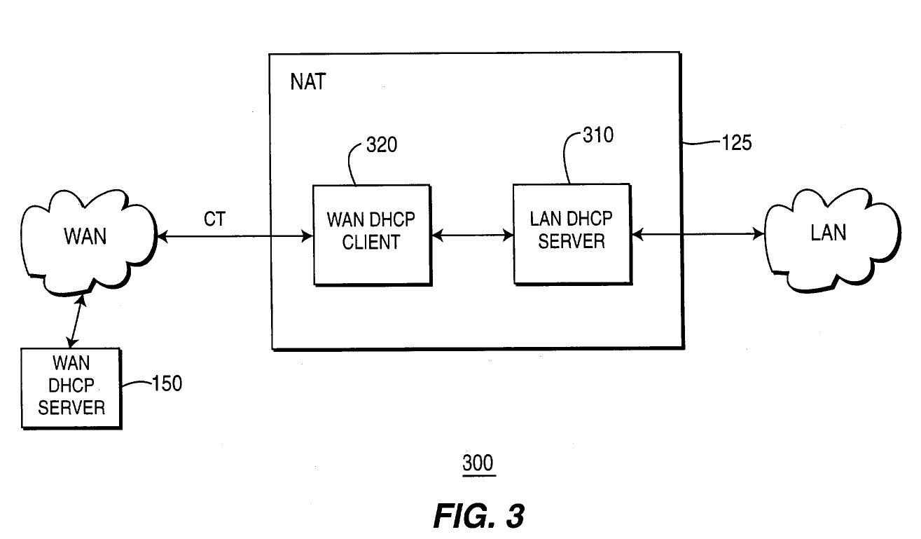

FIG. 3 depicts a block diagram illustrating an exemplary network address translation process of the NAT device 125 in accordance with the principles of the present invention. The NAT device 125 of FIG. 3 comprises a DHCP server 310 on the LAN side and a DHCP client 320 on the WAN side. The DHCP server 310 and the DHCP client 320 can be essentially computer programs or other firmware or software that implement Dynamic Host Configuration Protocol (DHCP) defined in Internet RFC-2131 and RFC-2132, which are incorporated herein by reference in their entireties.

Functionally, the DHCP server 310 provides the PCs 110 with IP addresses that are available on the LAN side, isolated from the WAN side. Similarly, the DHCP client 320 provides IP addresses of WAN devices for communication with the Internet 140. CPE devices (i.e., PCs 110), DHCP servers (i.e., DHCP server 310) and DHCP clients (i.e., DHCP client 320) communicate using DHCP protocol. DHCP protocol uses the concept of a lease of quantity of time during which a given IP address is assigned (i.e., the amount of time that a client PC 110 uses to receive information from the Internet 140). When a DHCP lease request from a PC 110 is communicated to the DCHP server 310, the DCHP server 310 allocates an IP address for communication to the PC 110 and establishes a lease time for processing the DHCP lease request from the PC 110. Additionally, the DCHP client 320 issues a DHCP lease request for an IP address from the Internet 140 corresponding to the information requested by the PC 110. The WAN DHCP server 150 on the WAN side returns an appropriate IP address to the DCHP client 320 and issues a lease time to the DCHP client 320 to learn what the appropriate configuration parameters are (i.e., DNS and domain name parameters) to process the DHCP request from the PC 110. Although the NAT 125 of FIG. 3 depicts the DCHP server 310 and the DHCP client 320 as two separate components, the DCHP server 310 and the DHCP client 320 can comprise a single computer or other systems that implement DHCP but function as two separate components.

When a LAN CPE device (PC 110) requests a lease from the DHCP server 310 before the WAN side DHCP client 320 has successfully obtained its own lease from the WAN DHCP server 150 to learn which relevant DNS IPs and domain name parameters are to be transferred to the PC 110, a long lease time granted by the DHCP server 310 to the requesting PC 110 would result in a long period of inactivity for the requesting PC 110. That is, because the WAN side DHCP client 320 has not obtained the appropriate information required by the requesting LAN CPE device, the WAN-type information required by the requesting LAN CPE device cannot be provided by the DHCP 320 during the lease time granted by the DHCP server 310 and, thus, the granted lease time would prove ineffective and therefore, wasted.

In one embodiment of the present invention, a method for overcoming the shortcomings of the DHCP server 310 granting long lease times to the requesting PC 110 before the DHCP client 320 receives a lease grant from the WAN DHCP server 150, comprises of the DHCP server 310 granting relatively short lease times to the requesting PC 110 until the WAN side DHCP client 320 obtains its WAN lease time and contains the associated IPs and configuration parameters. Short is on the order of tens of seconds in length, as opposed to the tens of thousands of seconds in length usually associated with conventional lease times. For example, conventional long lease times are typically greater than ten thousand seconds (i.e., 15000 seconds), and relatively short lease times in accordance with the present invention are less than one thousand seconds (i.e., 100 seconds). However, because of the wide applicability of this concept; it may be restated that a relatively short lease time is any lease time less than an arbitrary period of time, T. Similarly, a relatively long lease time may be considered to be any lease time greater than an arbitrary period of time, T.

In the CM 120, the DHCP server 310 assumes that when the DHCP client 320 has successfully obtained a valid IP lease, the DHCP client 320 has as complete a set of network information as it will obtain. So, upon a lease request from a CPE device (PC 110), the DHCP server 310 queries the DHCP client 320 to determine if the DHCP client 320 has a valid IP lease of its own. If the DHCP server 310 finds that the DHCP client 320 has a valid lease, it grants longer leases (on the order of tens of thousands of seconds or greater) to the requesting PC 110. During the long lease times the DHCP server 310 transfers relevant information such as DNS IPs and domain names to the requesting PC 110, if the DHCP client 320 has such information. If the DHCP client obtains a valid lease, but network information such as DNS IPs or domain name are not known, the DHCP server 310 still proceeds with a longer lease time, assuming that the DHCP client 320 will never obtain such parameters. If the DHCP client 320 does not have a valid IP lease at the time of the DHCP lease request from a PC 110, the DHCP server 310 responds with a short lease time. The CPE devices (PCs 110) will, though, renew their leases often, so when the DHCP client 320 obtains its lease from the WAN DHCP server 150, the relevant WAN parameters and information are transferred immediately to the LAN DHCP server 310.

As a result of the relatively shorter lease times granted by the DHCP server 310 to the requesting PC 110, the period of inactivity of the PC 110 is minimized. Additionally, the period of time that the particular IP address assigned to the requesting PC 110 by the DHCP server 310 is unavailable, is also minimized. That is, because the IP address is owned by the client between the lease acknowledgment and the lease renewal by the client (PC 110), a shorter lease time results in shorter periods of unavailability for an assigned IP.

FIG. 4 depicts a flow diagram of an embodiment of a method of the present invention. The method 400 is entered at step 402 when a DHCP lease request from a CPE device is received by a DHCP server. At step 404, the DHCP server determines whether or not a corresponding DHCP client has received its own WAN IP lease. If the DHCP client has received its own WAN IP lease, the method 400 proceeds to step 406, if the DHCP client has not received its own WAN IP lease, the method 400 proceeds to step 408.

At step 406, the DHCP server offers the requesting CPE device a relatively long lease time and delivers the required WAN parameters such as DNS IPs to the requesting CPE device. That is, a DHCP server assumes that when a DHCP client has successfully obtained a valid IP lease, the DHCP client has as complet a set of network information as it will obtain. As such, the DHCP server offers the requesting CPE device a relatively long lease time and delivers the required WAN parameters such as DNS IPs to the requesting CPE device. The method 400 is then exited and the DHCP server waits for another DHCP lease request from a CPE device.

At step 408, the DHCP server offers the requesting CPE device a relatively short lease time. That is, if a DHCP client does not have a valid IP lease at the time of the DHCP lease request from a CPE, the DHCP server responds with a short lease time granted to the requesting CPE. The CPE devices (PCs) will, though, renew their leases often, so when the DHCP client obtains its lease from a WAN DHCP server, the relevant WAN parameters and information are transferred immediately to the DHCP server and subsequently to the requesting CPE. The method 400 is then exited and the DHCP server waits for another DHCP lease request from a CPE device.

While the forgoing is directed to some embodiments of the present invention, other and further embodiments of the invention may be devised without departing from the basic scope thereof. As such, the appropriate scope of the invention is to be determined according to the claims, which follow.

What is claimed is:

1. A method, comprising:
receiving at a first dynamic host configuration protocol (DHCP) device, a message requesting allocation of an IP address to a client; and
allocating to the requesting client a lease time less than time period T if a second DHCP device has not obtained the requested allocation of said IP address.

2. The method of claim 1, further comprising:
allocating to the requesting client a lease time greater than time period T if said second DHCP device has obtained the requested allocation of said IP address.

3. The method of claim 2, wherein said time period T is greater than ten thousand seconds.

4. The method of claim 1, wherein said time period T is less than one thousand seconds.

5. The method of claim 1, wherein said first DHCP device comprises a DHCP server.

6. The method of claim 1, wherein said second DHCP device comprises a DHCP client.

7. The method of claim 1, wherein said message is a DHCP lease request.

8. The method of claim 7, wherein said IP address lease further comprises a Domain Name Server (DNS) IP address and domain name associated with said requested IP address.

9. An apparatus, comprising:
a first DHCP device, for receiving messages from a client and issuing lease times to said client in response to the messages, the messages requesting allocation of an IP address to a client;
a second DHCP device, for receiving IP address leases from a wide area network associated with said requested IP addresses;
a memory for storing communications parameters and instructions; and
a processor, upon executing said instructions, configured to:
receive at said first DHCP device, a message requesting allocation of an IP address to a client; and
allocate to said client a lease time less than time period T, if said second DHCP device has not obtained the requested allocation of said IP address lease.

10. The apparatus of claim 9, wherein said first DHCP device comprises a DHCP server.

11. The apparatus of claim 9, wherein said second DHCP device comprises a DHCP client.

12. The apparatus of claim 9, wherein said apparatus is incorporated into an edge networking device.

13. The apparatus of claim 12, wherein said edge networking device is a cable modem.

14. The apparatus of claim 12, wherein said edge networking device is a router.

15. Computer-readable medium for storing a set of instructions, wherein when said set of instructions is executed by a processor perform a method comprising:
receiving at a first dynamic host configuration protocol (DHCP) device, a message requesting allocation of an IP address to a client; and
allocating to the requesting client a lease time less than time period T if a second DHCP device has not obtained the requested allocation of said IP address.

16. An apparatus comprising:
means for receiving at a first dynamic host configuration protocol (DHCP) device, a message requesting allocation of an IP address to a client; and
means for allocating to the requesting client a lease time less than time period T if a second DHCP device has not obtained the requested allocation of said IP address.
